(19) United States
(12) Patent Application Publication
(10) Pub. No.: US 2018/0057915 A1
(43) Pub. Date: Mar. 1, 2018

(54) STEEL ALLOYS AND CYLINDER LINERS THEREOF

(71) Applicant: GM GLOBAL TECHNOLOGY OPERATIONS LLC, Detroit, MI (US)

(72) Inventors: Huaxin Li, Rochester Hills, MI (US); Jianghuai Yang, Rochester Hills, MI (US); Qigui Wang, Rochester Hills, MI (US); William Miller, Birmingham, MI (US)

(21) Appl. No.: 15/251,259

(22) Filed: Aug. 30, 2016

(51) Int. Cl. C22C 38/14; C22C 38/06; C22C 38/04; C22C 38/02; C22C 38/00; F02F 1/00

(52) U.S. Cl. CPC C22C 38/14; C22C 38/06; C22C 38/04; C22C 38/02; C21D 2211/009; F02F 1/004; C21D 2211/005; C21D 2211/008; C22C 38/002

(57) ABSTRACT

Steel alloys and steel alloy cylinder liners are provided. Steel alloys can comprise iron, about 0.8% to about 2.1% manganese, about 0.10% to about 0.40% silicon, about 0.05% to about 0.30% sulfur, about 0.06% to about 0.16% phosphorus, about 0.09% to about 0.21% titanium, about 0.09% to about 0.21% aluminum, and either low carbon and about 0.0005% to about 0.0055% boron, or medium carbon. The steel alloy cylinder liners can be capable of achieving a mirror-like finish. The steel alloy cylinder liners can comprise ultra-thin wall thickness of less than about 1.5 mm or about 1.0 mm to about 0.5 mm. The steel alloy cylinder liners can comprise a Young's modulus of at least 200 GPa. The steel alloy cylinder liners can comprise a Young's modulus to density ratio of at least about 25.64 GPa/(g/cm³).

During a combustion cycle of an internal combustion engine (ICE), air/fuel mixtures are provided to cylinders within an engine block of the ICE. The air/fuel mixtures are compressed and/or ignited and combusted to provide output torque via pistons positioned within the cylinders. As the pistons move within the cylinders, friction between the piston and cylinder and the presence of fuel can wear and degrade the cylinder surfaces. Additionally, combustion pressure and piston side loading can pose significant amount of stresses on the cylinder bores.

Historically, ICEs have employed cylinder liners to prevent wear or damage to the engine block. Cylinder liners have been made of various grades of cast iron (e.g., gray iron). Cast iron is selected in part for its low production cost, easy manufacture, satisfactory thermal conductivity which minimizes bore distortion, and good wear resistance due to the presence of free graphite which acts as a lubricant and reduces friction with the piston ring pack. Unfortunately, gray iron materials impart significant undesired weight to an engine block, due to their high densities (e.g., >7.1 g/cm³) and high wall thicknesses (e.g., about 2 to 4 mm) needed to compensate for poor mechanical properties (e.g., low strength and low modulus of elasticity). High wall thicknesses increase the weight of the engine and can reduce overall ICE system efficiency, for example where the engine is a diesel or gasoline engine and powers a vehicle. Further, gray iron cylinder liners are susceptible to cracking during service, in part due to the residual stress inherited from the casting process.

Thermal spray steel cylinder bores have been identified as an alternative to gray iron cylinder lines, particularly due to the weight saving advantages provided by the very thin wall thicknesses (e.g., 100-300 μm). However, manufacturing thermal spray bores is complex and requires expensive materials and equipment, yet the performance characteristics are only marginally enhanced, if at all. For example, improvements in wear resistance and friction reduction are minimal relative to gray iron cylinder liners. Further, the high thermal conductivity of thermal spray bores increases thermal management complexity due to high heat loss between the coating layer and cylinder bore, and the susceptibility to cylinder bore distortion can induce unexpected blow-by and oil consumption.

### SUMMARY

According to an aspect of an exemplary embodiment, a steel alloy is provided. A steel alloy can comprise iron, low carbon, boron, about 0.8% to about 2.1% manganese, about 0.10% to about 0.40% silicon, about 0.05% to about 0.30% sulfur, about 0.06% to about 0.16% phosphorus, about 0.09% to about 0.21% titanium, and about 0.09% to about 0.21% aluminum. A steel alloy with low carbon can comprise about 0.17% to about 0.26% carbon. A steel alloy with boron can comprise about 0.0005% to about 0.0055% boron.

According to an aspect of an exemplary embodiment, a steel alloy is provided. A steel alloy can comprise iron, medium carbon, about 0.8% to about 2.1% manganese, about 0.10% to about 0.40% silicon, about 0.05% to about 0.30% sulfur, about 0.06% to about 0.16% phosphorus, about 0.09% to about 0.21% titanium, and about 0.09% to about 0.21% aluminum. A steel alloy with medium carbon can compiise about 0.24% to about 0.51% carbon. The medium carbon steel alloy can be boron-free.

According to an aspect of an exemplary embodiment, a steel alloy cylinder liner is provided. A steel alloy cylinder liner can comprise iron, about 0.8% to about 2.1% manganese, about 0.10% to about 0.40% silicon, about 0.05% to about 0.30% sulfur, about 0.06% to about 0.16% phosphorus, about 0.09% to about 0.21% titanium, about 0.09% to about 0.21% aluminum, and either low carbon and about 0.0005% to about 0.0055% boron, or medium carbon. The cylinder liner can be capable of achieving a mirror-like finish. The cylinder liner can comprise a wall thickness of less than about 1.50 mm. The cylinder liner can comprise a wall thickness of about 0.5 mm to about 1.0 mm. The cylinder liner can comprise a Young's modulus of at least 200 GPa. The cylinder liner can comprise a Young's modulus to density ratio of at least about 25.64 GPa/(g/cm³).

Although many of the embodiments herein describe steel alloys for use as cylinder liners, the steel alloys provided herein are generally suitable for additional applications. Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a side view of steel alloy cylinder liner according to one or more embodiments;

FIG. 2 illustrates a flow diagram of a method for making and installing a steel alloy cylinder liner, according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The compositions of the steel alloys of the present disclosure are designed to provide features such as high strength, preferred microstructures, and good machinability. The steel alloys are self-hardening and self-lubricating, which provides advantageous friction and wear benefits for numerous industrial applications. The compositions of the alloys of the present disclosure exhibit a high Young's modulus which provides high stiffness and low distortion. The advantageous structural characteristics exhibited by the alloys of the present disclosure lend weight-saving opportunity to various industrial applications such as engine block cylinder liners. The alloys can include low to medium carbon for strength. The alloys can include boron and/or manganese to enhance self-hardening aspects during manufacturing. The alloys can include sulfur and/or phosphorus to enhance machinability and/or self-lubrication aspects. The alloys can include titanium and/or aluminum to enhance wear resistance aspects. Generally, the alloys described herein will be defined as a percentage (by weight) of one or more alloying elements or compounds (e.g., carbon, steadite, silicon, etc.) with the balance of the alloy comprising iron, or substantially comprising iron. In some embodiments the disclosed alloying elements or compounds include a normal degree of industry-standard impurity (e.g., 99.9% purity).

The steel alloys provided herein comprise iron, carbon, and one or more alloying elements or compounds. The steel alloy can include iron in one or more microstructures, including ferrite, pearlite, bainite and martensite. In some embodiments the steel alloy microstructure can include at least about 50% by volume, at least about 55% by volume, or at least 60% by volume martensite. The steel alloys can optionally further comprise high temperature-transformed iron microstructures including primary ferrite, fine pearlite, and bainite. The steel alloys can include up to about 15% by volume ferrite, up to about 17.5% by volume ferrite, or up to about 20% by volume ferrite. The steel alloys can include up to about 25% by volume pearlite, up to about 27.5% by volume pearlite, or up to about 30% by volume pearlite. The steel alloys can optionally include up to about 5% by volume bainite, up to about 7.5% by volume bainite, or up to about 10% by volume bainite. In a specific embodiment, a steel alloy can comprise greater than about 60% by volume martensite, about 10-20% by volume ferrite, about 20-30% by volume pearlite, and optionally about 5-10% by volume bainite. In a specific embodiment, a steel alloy can comprise greater than about 60% by volume martensite, less than about 20% by volume ferrite, less than about 30% by volume pearlite, and optionally less than about 10% by volume bainite. Because the desired steel alloy microstructures can achieved by natural cooling and/or forced air cooling, the need for quenching is obviated.

In some particular embodiments, an alloy can comprise low carbon and boron. In other particular embodiments, an alloy can comprise medium carbon and no boron. Low carbon can be defined as less than about 0.26% carbon, less than about 0.25% carbon, or less than about 0.24% carbon. Low carbon can be defined as no more than about 0.26% carbon, no more than about 0.25% carbon, or no more than about 0.24% carbon. Low carbon can be defined as about 0.17% carbon to about 0.26% carbon, about 0.18% carbon to about 0.25% carbon, or about 0.19% carbon to about 0.24% carbon. Medium carbon can be defined as less than about 0.51% carbon, less than about 0.50% carbon, or less than about 0.49% carbon. Medium carbon can be defined as no more than about 0.51% carbon, no more than about 0.50% carbon, or no more than about 0.49% carbon. Medium carbon can be defined as about 0.24% carbon to about 0.51% carbon, about 0.25% carbon to about 0.50% carbon, or about 0.26% carbon to about 0.49% carbon. Low to medium carbon content can enhance the strength of the alloy, for example.

Alloys including boron can comprise at least about 0.001% boron, or at least about 0.0015% boron. Alloys including boron can comprise less than about 0.005% boron, or less than about 0.0055% boron. Alloys including boron can comprise about 0.0005% boron to about 0.0055% boron, about 0.001% boron to about 0.005% boron, or about 0.0015% boron to about 0.0045% boron. Alloys with no boron can comprise less than about 0.0005% boron, or less than about 0.0001% boron. Alloys with no boron can comprise 0% boron. Boron can lend enhance self-hardening effects to the alloy, for example after manufacturing.

In some embodiments, the alloy can optionally include manganese. Alloys including manganese can include less than about 2.1% manganese, less than about 2.0% manganese, or less than about 1.9% manganese. Alloys including manganese can include at least about 0.8% manganese, at least about 0.9% manganese, or at least about 1.0% manganese. Alloys including manganese can include about 0.8% manganese to about 2.1% manganese, about 0.9% manganese to about 2.0% manganese, or about 1.0% manganese to about 1.9% manganese. In some embodiments, manganese is present in its elemental form. Additionally or alternatively, manganese is present as a compound. Manganese compounds can be manganese sulfides, such as MnS and MnS₂, among others. Manganese sulfides are soft and easily deformed, and readily take the direction of steel rolling and/or forming. Manganese compounds in the alloy can lubricate tools during machining and reduce tool wear. Additionally or alternatively, manganese compounds in the alloy can improve steel liner lubrication during use in an ICE. The manganese compounds can be tined-dispersed, for example. Elemental manganese and manganese compounds which are “fin.e-dispersed” typically have a particle size of less than about 100 μm. Fine-dispersed elemental metals and/or compounds are predominantly located near grain boundaries or sub-grain boundaries, where the compounds precipitate during cooling. Fine-dispersed elemental metals and/or compounds help reduce grain size, and stabilize grain boundaries thereby increasing strength and stiffness at high temperatures. Manganese can enhance self-hardening effects to the alloy, for example after manufacturing.

In some embodiments, the alloy can optionally include silicon. Alloys including silicon can include less than about 0.30% silicon less than about 0.35% silicon or less than about 0.40% silicon. Alloys including silicon can include at least about 0.10% silicon, at least about 0.15% silicon, or at least about 0.20% silicon. Alloys including silicon can include about 0.10% silicon to about 0.40% silicon, about 0.15% silicon to about 0.35% silicon, or about 0.20% silicon to about 0.30% silicon. In some embodiments, silicon is present in its elemental form. In one example elemental silicon is dissolved within ferrite to enhance strength. Additionally or alternatively, silicon is present as a compound.

In some embodiments, the alloy can optionally include sulfur. Alloys including sulfur can include less than about 0.30% sulfur less than about 0.25% sulfur or less than about 0.20% sulfur. Alloys including sulfur can include at least about 0.05% sulfur, at least about 0.10% sulfur, or at least about 0.15% sulfur. Alloys including sulfur can include about 0.05% sulfur to about 0.30% sulfur, about 0.10% sulfur to about 0.25% sulfur, or about 0.15% sulfur to about 0.20% sulfur. The sulfur content of the steel alloys disclosed herein represents a departure from the typical low sulfur content of modern clean steel (e.g., <0.05%), which is chosen to avoid the adverse effects of higher sulfur content on hot forming and fatigue performance, for example. The relatively high sulfure content of the steel alloys provided herein is utilized to enhance machinability and self-lubication of the alloy. This sulfur content is practicable despite the attendant fatigue strength reduction due to the synergistic effects (e.g., overall enhanced Young's modulus and tensile strength) of the alloying elements, carbon content, and iron characteristics within the alloys. Further, the overall fatigue strengths of the alloys disclosed herein are still superior to most gray iron and thermally sprayed steel liners known in the art. In some embodiments, sulfur is present in its elemental form. Additionally or alternatively, sulfur is present as a compound. Sulfur compounds can include manganese sulfides (e.g., MnS and MnS₂), iron sulfides (e.g., FeS, FeS₂, Fe₂S₃, Fe₃S₄, and Fe₇S₈), and H₂S, among others. In some embodiments, sulfur compounds can additionally or alternatively comprise sulfides of zinc, lead, and copper. The sulfur compounds can be fined-dispersed, for example. Elemental sulfur and sulfur compounds which are “fine-dispersed” typically have a particle size of less than about 500 μm. Sulfur, particularly sulfides, can lend one or more of increased machinability and self-lubrication properties to the alloy, for example.

In some embodiments, the alloy can optionally include phosphorus. Alloys including phosphorus can include less than about 0.16% phosphorus less than about 0.15% phosphorus or less than about 0.14% phosphorus. Alloys including phosphorus can include at least about 0.04% element, at least about 0.05% element, or at least about 0.06% element. Alloys including phosphorus can include about 0.06% phosphorus to about 0.16% phosphorus, about 0.05% phosphorus to about 0.15% phosphorus, or about 0.04% phosphorus to about 0.14% phosphorus. The phosphorus content of the steel alloys disclosed herein represents a departure from the typical low phosphorus content of modern clean steel (e.g., less than about 0.04% in structural steel, or less than about 0.035% in tool steel), which is chosen to avoid the adverse effects of higher phosphorus content on low temperature properties (e.g., tensile ductility, ipmact strength, and fracture toughness), for example. The relatively high phosphorus content of the steel alloys provided herein is utilized to enhance machinability of the alloy. This phosphorus content is practicable despite the attendant reduction in low temperature properties due to the synergistic effects (e.g., overall enhanced Young's modulus and tensile strength) of the alloying elements, carbon content, and iron characteristics within the alloys. In some embodiments, phosphorus is present in its elemental form. Additionally or alternatively, phosphorus is present as a compound. Phosphorus compounds can include phosphides, such as iron phosphides PO₂, and Al₃P, among others. In particular, phosphorus compounds within the alloy can include steadite. Phosphorus can lend one or more of increased machinability and self-lubrication properties to the alloy, for example.

In some embodiments, the alloy can optionally include titanium. Alloys including titanium can include less than about 0.21% titanium less than about 0.20% titanium or less than about 0.19% titanium. Alloys including titanium can include at least about 0.09% titanium, at least about 0.10% titanium, or at least about 0.11% titanium. Alloys including titanium can include about 0.09% titanium to about 0.21% titanium, about 0.10% titanium to about 0.20% titanium, or about 0.11% titanium to about 0.19% titanium. In some embodiments, titanium is present in its elemental form. Additionally or alternatively, titanium is present as a compound. Titanium compounds can include titanium nitrides, such as TiN, Al₃Ti, TiC, Ti₄C₂S₂, and Ti₃O₅, among others. The titanium compounds can be fined-dispersed, for example. Elemental titanium and titanium compounds which are “fine-dispersed” typically have a particle size of less than about 100 μm. Microalloyed titanium can enhance wear resistance of the alloy.

In some embodiments, the alloy can optionally include aluminum. Alloys including aluminum can include less than about 0.21% aluminum less than about 0.20% aluminum or less than about 0.19% aluminum. Alloys including aluminum can include at least about 0.09% aluminum, at least about 0.10% aluminum, or at least about 0.11% aluminum. Alloys including aluminum can include about 0.09% aluminum to about 0.21% aluminum, about 0.10% aluminum to about 0.20% aluminum, or about 0.11% aluminum to about 0.19% aluminum. In some embodiments, aluminum is present in its elemental form. Additionally or alternatively, aluminum is present as a compound. Aluminum compounds can include aluminum nitrides, such as AlN, Al₂O₃, Al₃P, Al₃Ti, and AlFeSi, among others. The aluminum compounds can be fined-dispersed, for example. Elemental aluminum and aluminum compounds which are “fine-dispersed” typically have a particle size of less than about 100 μm. Microalloyed aluminum can enhance strength and wear resistance of the alloy, for example.

In some embodiments, the alloy can optionally include nitrogen. In some embodiments, alloys including nitrogen can include about 0.001% nitrogren to about 0.025% nitrogen. Nitrogren can be included to facilitate the formation of AlN and/or TiN, for example. Nitrogen can be used to improve stength, for example.

In a particular embodiment, a steel alloy can comprise iron, about 0.17% to about 0.26% carbon, about 0.0005% to about 0.0055% boron, about 0.8% to about 2.1% manganese, about 0.10% to about 0.40% silicon, about 0.05% to about 0.30% sulfur, about 0.06% to about 0.16% phosphorus, about 0.09% to about 0.21% titanium, and about 0.09% to about 0.21% aluminum.

In a particular embodiment, a steel alloy can comprise iron, about 0.18% to about 0.25% carbon, about 0.001% to about 0.005% boron, about 0.001% to about 0.005% boron, about 0.9% to about 2.0% manganese, about 0.15% to about 0.35% silicon, about 0.10% to about 0.25% sulfur, about 0.05% to about 0.15% phosphorus, about 0.1% to about 0.2% titanium, and about 0.1% to about 0.2% aluminum.

In a particular embodiment, a steel alloy can comprise iron, about 0.19% to about 0.24% carbon, about 0.0015% boron to about 0.0045% boron, about 1.0% to about 1.9% manganese, about 0.20% silicon to about 0.30% silicon, about 0.15% to about 0.20% sulfur, about 0.04% to about 0.14% phosphorus, about 0.11% to about 0.19% titanium, and about 0.11% to about 0.19% aluminum.

In a particular embodiment, a steel alloy can comprise iron, about 0.24% to about 0.51% carbon, about 0.8% to about 2.1% manganese, about 0.10% to about 0.40% silicon, about 0.05% to about 0.30% sulfur, about 0.06% to about 0.16% phosphorus, about 0.09% to about 0.21% titanium, and about 0.09% to about 0.21% aluminum. This particular alloy can be boron-free.

In a particular embodiment, a steel alloy can comprise iron, about 0.25% to about 0.50% carbon, about 0.9% to about 2.0% manganese, about 0.15% to about 0.35% silicon, about 0.10% to about 0.25% sulfur, about 0.05% to about 0.15% phosphorus, about 0.1% to about 0.2% titanium, and about 0.1% to about 0.2% aluminum. This particular alloy can be boron-free.

In a particular embodiment, a steel alloy can comprise iron, about 0.26% to about 0.49% carbon, about 1.0% to about 1 9% manganese, about 0.20% silicon to about 0.30% silicon, about 0.15% to about 0.20% sulfur, about 0.04% to about 0.14% phosphorus, about 0.11% to about 0.19% titanium, and about 0.11% to about 0.19% aluminum. This particular alloy can be boron-free.

The alloys described above can have advantageous material characteristics such as being capable of achieving a mirror-like finish which decreases friction and material wear in industrial applications such as those which involve repetitive contact with other objects (e.g., engine pistons ring packages). The alloys above can exhibit surface qualities as defined by ISO 13565-2 parameters including reduced peak height (Rpk), core roughness depth (Rk), reduced valley depth (Rvk), upper limit of the core roughness (MR1) and lowest limit of the core roughness (MR2). The alloys described herein can have an Rpk of less than about 0.13 μm, less than about 0.12 μm, less than about 0.11 μm, or less than about 0.10 μm. The alloys described herein can have an Rk of less than about 0.23 μm, less than about 0.22 μm, less than about 0.21 μm, or less than about 0.20 μm. The alloys described herein can have an Rvk of greater than about 1.2 μm, greater than about 1.3 μm, greater than about 1.4 μm, or greater than about 1.5 μm. The alloys described herein can have an MR1 of less than 13%, less than 12%, less than 11%, or less than 10%. The alloys described herein can have an MR2 of greater than 74%, greater than 76%, greater than 78%, or greater than 80%. The alloys described herein can have a honed crosshatch angle greater than about 55°, greater than about 57°, greater than about 59°, or greater than about 60°. Higher honed crosshatch angles can increase oil flow ad lead to thin oil films. Thin oil films can reduce shear resistance at higher engine speeds and accordingly reduce friction in the hydrodynamic lubrication regime as described by a Stribeck curve, for example.

In a particular embodiment, an alloy capable of achieving a mirror-like finish can have an Rpk of less than about 0.13 μm, an Rk of less than about 0.23 μm, an Rvk of greater than about 1.2 μm, an MR1 of less than 13%, and an MR2 of greater than 74%. In a particular embodiment, an alloy capable of achieving a mirror-like finish can have an Rpk of less than about 0.12 μm, an Rk of less than about 0.22 μm, an Rvk of greater than about 1.3 μm, an MR1 of less than 12%, and an MR2 of greater than 76%. In a particular embodiment, an alloy capable of achieving a mirror-like finish can have an Rpk of less than about 0.11 μm, an Rk of less than about 0.21 μm, an Rvk of greater than about 1.4 μm, an MR1 ofless than 11%, and an MR2 of greater than 78%. In a particular embodiment, an alloy capable of achieving a mirror-like finish can have an Rpk of less than about 0.10 μm, an Rk of less than about 0.20 μm, an Rvk of greater than about 1.5 μm, an MR1 of less than 10%, and an MR2 of greater than 80%.

The alloys described above can have advantageous material characteristics including density, Young's modulus, hardness, ultimate tensile strength, ductility, thermal conductivity, and thermal expansion. The alloys described above can have a density of about 7.7-7.8 g/cm³. The alloys described above can have a Young's modulus of at least 200 GPa, at least 205 GPa, or at least 210 GPa. The alloys described above can have a Young's modulus of about 200 GPa to about 210 GPa. The alloys described above can have a Young's modulus to density ratio (GPa/(g/cm³)) of at least about 25.64, at least about 26.45, or at least about 28.0. The alloys described above can have a Rockwell Hardness B-Scale (HRB) of about 95 to about 110. The alloys described above can have a Rockwell Hardness C-Scale (HRC) of about 20 to about 38. The alloys described above can have an ultimate tensile strength of about 600-900 MPa. The alloys described above can have a ductility of about 5% to about 10%. The alloys described above can have a thermal conductivity of about 31 BTU·ft/(hr·ft²·° F.) at 77° F. The alloys described above can have a thermal expansion of about 12.6 μm/(m·° C.) at 77° F.

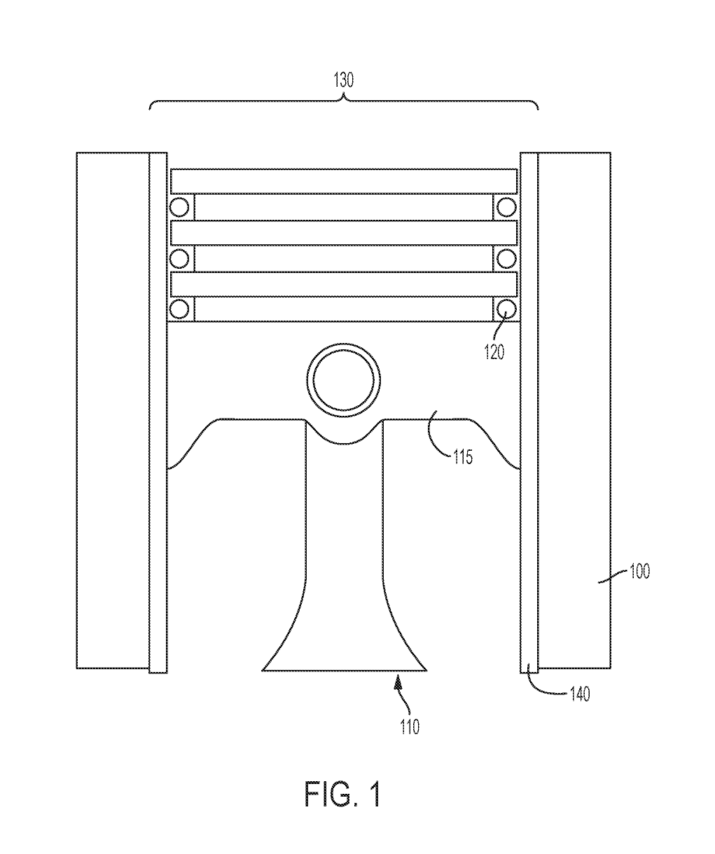

The steel alloys provided herein can be utilized as engine block cylinder liners, as shown in FIG. 1 which illustrates a side view of a piston 110 positioned within an engine block 100 cylinder 130. Piston 110 comprises a head 115 with one or more rings 120. Cylinder liner 140 can comprise one or more steel alloys disclosed herein and can be positioned within cylinder 130. In some embodiments, rings 120 comprise one or more steel alloys disclosed herein. During a combustion cycle of an internal combustion engine (ICE), air/fuel mixtures are provided to cylinders (e.g., cylinder 130) of the ICE. The air/fuel mixtures are compressed and/or ignited and combusted to provide output torque via pistons (e.g., piston 110) positioned within the cylinders. Cylinder liner 140 can come in contact with one or more rings 120 and/or piston head 115, during operation of an ICE. Cylinder liner 140 can serve to prevent wear or degradation of the engine block 100 from contact with the piston 110 and/or one or more of fuel and combustion gases. Generally, cylinder liner 140 comprises a tubular shape. In some embodiments, cylinder liner 140 comprises a circular cross section. In some embodiments, cylinder liner 140 comprises an elliptical cross section. Cylinder liner 140 outer, engine block-side contour can substantially conform to the inner contour of the cylinder 130. Cylinder liner 140 inner, piston-side contour can substantially conform to the outer contour of the piston head 115 and/or rings 120. The physical properties of cylinder liner 140 allow for engine block 100 to comprise aluminum.

Cylinder liners 140 comprising the disclosed steel alloys possesses advantages over conventional cylinder liners, such as gray iron liners or advanced thermal sprayed steel liners, due to increased strength and stiffness (e.g., tensile strength and Young's modulus), high compatibility with piston ring packages, and lower wear rate, physical distortion, and friction with pistons. In particular, the high strength and stiffness of the disclosed steel alloys provides thinner, lighter cylinder liners relative to the conventional materials.

Cylinder liner 140 can comprise the steel alloys disclosed above and have a wall thickness of less than about 1.50 mm, less than about 1.25 mm, less than about 1.00 mm, less than about 0.75 mm, about 0.50 mm, or less than about 0.50 mm. Cylinder liner 140 can comprise the steel alloys disclosed above and have a wall thickness of about 0.77 mm to about 0.48 mm, about 0.76 mm to about 0.49 mm, or about 0.75 mm to about 0.50 mm. In some embodiments, cylinder liner 140 can comprise the steel alloys disclosed above and have a wall thickness of about 1.0 mm to about 0.5 mm. The wall thickness can be defined as the distance between the outer, engine block-side and the inner, piston-side. The thin wall thickness can lend weight saving advantages to an ICE. For example, a cylinder liner comprising a steel alloy disclosed herein can comprise a wall thickness of 0.50 mm while a gray iron cylinder liner typically requires a wall thickness of up to 2.50 mm. In this example, the steel alloy cylinder liner provides a weight reduction of about 64% to about 75%.

Cylinder liner 140 can reduce manufacturing cost and/or complexity associated with conventional cylinder liner manufacturing. Cylinder liner 140 can be manufactured using mature technology, such as hot finished seamless (HF S) which manufactures the cylinder liner 140 to a desired outer diameter and wall thickness, hot extrusion, or draw over mandrel (DOM) for electric resistance seam welding. Cylinder liner 140 can accordingly be manufactured to a near-net shape with minimal machining stock. Cylinder liner 140 can air-cool and self-harden. Cylinder 140 can be shot blasted on the outer wall and/or ends prior to descaling and installation in engine block 100. Cylinder liner 140 can be lightly machined on the inner wall prior to applying a mirror-like finish. When cylinder liner 140 is used in conjunction with an aluminum engine block 100, the liner can be installed using a press-in-place process (PIP). PIP installation can be used when cylinder liner 140 comprises a steel alloy with low carbon content, for example. When cylinder liner 140 comprises medium carbon content, cast in place (CIP) honing methods can be utilized to apply a mirror-like finish to the inner wall.

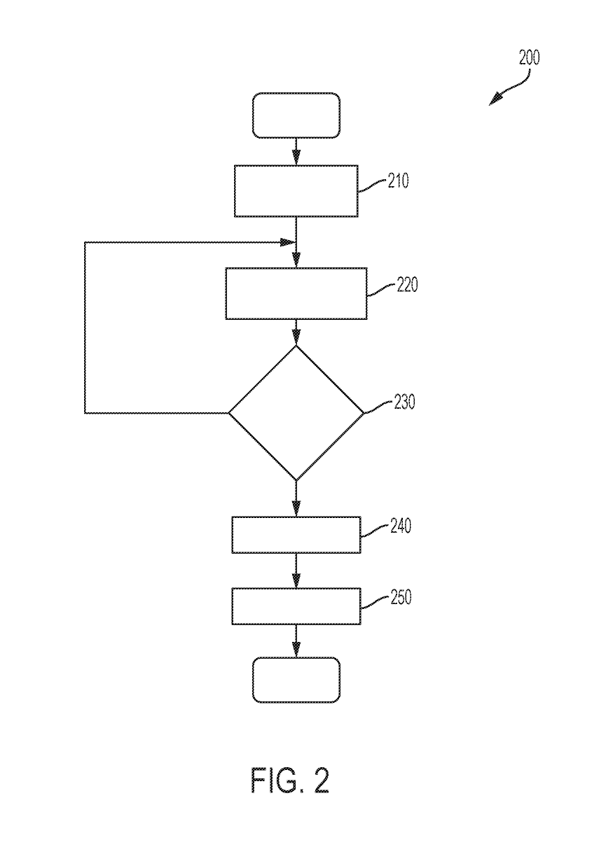

FIG. 2 illustrates a flow diagram of a method 200 for making and installing a steel alloy cylinder liner. Method 200 can comprise forming 210 a steel tube, optionally precision forming 220, and determining 230 if the dimension tolerance targets have been met. Forming 210 can comprise rough extrusion or DOM. Forming 210 can yield a tube inner diameter slightly smaller than the desired inner diameter (e.g., about 0.5 mm to about 1 mm smaller than the desired inner diameter, and a wall thickness of about 1 mm to about 1.5 mm). Forming 210 can be carried out under warm conditions (e.g., 500° C. or above) to reduce residual stress in the liner and facilitate material deformation. Precision forming 220 can comprise precision extrusion or DOM. Precision extrusion can include near-net-shape precision extraction processes. Precision forming 220 can include cold or warm extrusion. Precision extrusion can yield a tube inner diameter within a tolerance of about 20 μm relative to the desired inner diameter. Dimension tolerance targets can include one or more of tube outer diameter, tube inner diameter, and tube wall thickness. If dimension tolerance targets have not been met, optional precision forming 220 is performed. Optional precision forming 220 can be continually performed until a desired dimension tolerance targets are met. When dimension tolerance targets are met, method 200 then subsequently comprises installing 240 the tubes. Installing 240 can comprise installing the tubes as cylinder liners in an engine block. Installing 240 can comprise a PIP installation. Method 200 can optionally include machining 250 the tubes. Machining 250 can achieve a mirror-like finish on at least a portion of the tube inner (i.e., piston-side) surface. Machining 250 can increase wear resistance. Machining 250 can comprise CIP honing methods.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A steel alloy comprising: iron, low carbon, boron, about 0.8% to about 2.1% manganese, about 0.10% to about 0.40% silicon, about 0.05% to about 0.30% sulfur, about 0.06% to about 0.16% phosphorus, about 0.09% to about 0.21% titanium, and about 0.09% to about 0.21% aluminum.

2. The alloy of claim 1, wherein low carbon comprises about 0.17% to about 0.26% carbon.

3. The alloy of claim 1, wherein the iron forms a microstructure including one or more of ferrite, pearlite, and martensite.

4. The alloy of claim 1 wherein one or more of the aluminum and titanium comprise one or more nitrides.

5. The alloy of claim 1, wherein the manganese comprises one or more sulfides.

6. The alloy of claim 1, wherein one or more of the titanium, aluminum, and manganese are fine-dispersed.

7. The alloy of claim 1, wherein the boron comprises about 0.0005% to about 0.0055% boron.

8. A steel alloy comprising: iron, medium carbon, about 0.8% to about 2.1% manganese, about 0.10% to about 0.40% silicon, about 0.05% to about 0.30% sulfur, about 0.06% to about 0.16% phosphorus, about 0.09% to about 0.21% titanium, and about 0.09% to about 0.21% aluminum.

9. The alloy of claim 8, wherein medium carbon comprises about 0.24% to about 0.51% carbon.

10. The alloy of claim 8, wherein the iron forms a microstructure including one or more of ferrite, pearlite, and martensite.

11. The alloy of claim 8, wherein one or more of the aluminum and titanium comprise one or more nitrides.

12. The alloy of claim 8, wherein the manganese comprises one or more sulfides.

13. The alloy of claim 8, wherein one or more of the titanium, aluminum, and manganese are fine-dispersed.

14. The alloy of claim 8, wherein the alloy is boron-free.

15. A steel alloy cylinder liner comprising a steel alloy including iron, about 0.8% to about 2.1% manganese, about 0.10% to about 0.40% silicon, about 0.05% to about 0.30% sulfur, about 0.06% to about 0.16% phosphorus, about 0.09% to about 0.21% titanium, about 0.09% to about 0.21% aluminum, and either low carbon and about 0.0005% to about 0.0055% boron, or medium carbon.

16. The cylinder liner of claim 15, wherein the cylinder liner is capable of achieving a mirror-like finish.

17. The cylinder liner of claim 15, further comprising a wall thickness of about 1.0 mm to about 0.5 mm.

18. The cylinder liner of claim 15, further comprising a Young's modulus of at least 200 GPa.

19. The cylinder liner of claim 15, further comprising a Young's modulus to density ratio of at least about 25.64 GPa/(g/cm³).

20. The cylinder liner of claim 15, wherein one or more of the titanium, aluminum, and manganese are fine-dispersed.
